(19) United States
(12) Patent Application Publication
(10) Pub. No.: US 2014/0156362 A1
(43) Pub. Date: Jun. 5, 2014

(54) ADVERTISING AND MARKETING PLATFORM

(71) Applicant: Maher Pedersoli, Tucson, AZ (US)

(72) Inventor: Maher Pedersoli, Tucson, AZ (US)

(21) Appl. No.: 13/692,217

(22) Filed: Dec. 3, 2012

(51) Int. Cl. G06Q 30/02

(52) U.S. Cl. CPC G06Q 30/0241
USPC 705/14.4

(57) ABSTRACT

Disclosed are a method, system, and/or apparatus of leasing a virtual advertisement product performed by a server comprising a processor coupled to a memory, the memory having instructions stored thereon which, when executed by the processor, cause the server to perform the method, including receiving an advertisement activation data from a mobile device comprising an image capture component. The advertisement activation data comprises an image data, a coded data, a text data, and/or a multimedia data captured by the mobile device. The method also includes extracting a temporal data and/or a geographical data concerning the advertisement activation data from the mobile device. Furthermore, the method includes querying a repository database for a stored copy of the advertisement activation data and adding the advertisement activation data to the repository database if the stored copy of the advertisement data is not found.

### FIELD OF TECHNOLOGY

This disclosure relates generally to a virtual advertisement platform designed to lease a virtual advertisement product to an advertiser based on temporal and geographical data related to an image captured by a user of a mobile device.

### BACKGROUND

The current climate of marketing may emphasize the importance of selective advertising. Specifically, modern advertising may benefit by focusing on an individual's age, gender, tastes, preferences, travel history, web search history, and other details associated with the individual. Advertising based on these criteria may have limited success in today's climate of mobile computing, however. Advertising firms may not utilize the rise of GPS-enabled, camera-equipped mobile devices in everyday use. As such, a great amount of advertisement space may be ignored, leading to a loss of sales, customers, and revenue.

### SUMMARY

Disclosed are a method, system, and/or apparatus to lease a virtual advertisement product to an advertiser based on temporal and geographical data related to an image captured by a user of a mobile device.

In one aspect, a method of leasing a virtual advertisement product performed by a server comprising a processor coupled to a memory, the memory having instructions stored thereon which, when executed by the processor, cause the server to perform the method, includes receiving an advertisement activation data from a mobile device comprising an image capture component. The advertisement activation data comprises an image data, a coded data, a text data, and/or a multimedia data captured by the mobile device. The method also includes extracting a temporal data and/or a geographical data concerning the advertisement activation data from the mobile device.

Furthermore, the method includes querying a repository database for a stored copy of the advertisement activation data. The method also involves adding the advertisement activation data to the repository database if the stored copy of the advertisement data is not found. Also, the method includes constructing a virtual advertising product based on the advertisement activation data. The method additionally comprises calculating an optimal price for the virtual advertising product by analyzing the temporal data and/or the geographical data of the advertisement activation data. The method also includes leasing the virtual advertising product to an advertiser based on the optimal price calculated.

The method may involve generating a customized advertisement to a user of the mobile device based on an analysis of the temporal data, the geographical data, the optimal price, and/or a content of the advertisement activation data. The advertisement activation data may be captured through a third-party photography sharing application implemented on the mobile device and the customized advertisement may be presented through the third-party photography sharing application implemented on the mobile device. The customized advertisement may comprise a text advertisement, an advertisement image, and/or a multimedia advertisement. The method may also involve decoding the advertisement activation data when the advertisement activation data is the coded data comprising a quick response (QR) code, a scan code, a bar code, a matrix code, and/or a graphic code. The method may further include extracting a set of user data from the user of the mobile device and taking into account the set of user data when calculating the optimal price for the virtual advertising product. The set of user data may comprise a gender data of the user, an age data of the user, and/or a contact information data of the user. The method may also involve continuously configuring the optimal price for the virtual advertising product based on an analysis of the set of user data and/or a popularity metric of the virtual advertising product.

In another aspect, a server to lease a virtual advertisement product performed by a server comprising a processor coupled to a memory, the memory having instructions stored thereon which, when executed by the processor, cause the server to receive an advertisement activation data from a mobile device comprising an image capture component. The advertisement activation data comprises an image data, a coded data, a text data, and/or a multimedia data captured by the mobile device. The server also includes instructions to extract a temporal data and/or a geographical data concerning the advertisement activation data from the mobile device. The server further comprises instructions to query a repository database for a stored copy of the advertisement activation data, and add the advertisement activation data to the repository database if the stored copy of the advertisement data is not found. The server also comprises instructions to construct a virtual advertising product based on the advertisement activation data and calculates an optimal price for the virtual advertising product by analyzing the temporal data and/or the geographical data of the advertisement activation data. The server further comprises instructions to lease the virtual advertising product to an advertiser based on the optimal price calculated.

The server may also comprise instructions to generate a customized advertisement to a user of the mobile device based on an analysis of the temporal data, the geographical data, the optimal price, and/or a content of the advertisement activation data. The advertisement activation data is captured through a third-party photography sharing application implemented on the mobile device and the customized advertisement is presented through the third-party photography sharing application implemented on the mobile device. The customized advertisement comprises a text advertisement, an advertisement image, and/or a multimedia advertisement. The server may also comprise instructions to decode the advertisement activation data when the advertisement activation data is the coded data comprising a quick response (QR) code, a scan code, a bar code, a matrix code, and/or a graphic code. The server may further comprise instructions to extract a set of user data from the user of the mobile device and take into account the set of user data when calculating the optimal price for the virtual advertising product. The set of user data may comprise a gender data of the user, an age data of the user, and/or a contact information data of the user. The server may also comprise instructions to continuously configure the optimal price for the virtual advertising product based on an analysis of the set of user data and/or a popularity metric of the virtual advertising product.

The methods, system, and/or apparatuses disclosed herein may be implemented in any means for achieving various aspects, and may be executed in a form of machine readable medium embodying a set of instruction that, when executed by a machine, causes the machine to perform any of the operations disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic diagram of capturing an image of a landmark to generate a customized advertisement to a user of a mobile device based on an extraction of a temporal data and a geographical data of an advertisement activation data and a calculation of an optimal price of a virtual advertisement product based on the customized advertisement, according to one embodiment.

FIG. 2 is a functional block diagram depicting components of the server having a processor communicatively coupled to an input/output interface and a memory, the memory comprising an advertisement activation database, a paid advertisements database, an advertising matching module, a leasing module, a decoding module, and a third party application module, according to one embodiment.

FIG. 3 is a schematic diagram of the memory of FIG. 2, demonstrating a query of an advertisement activation database for a stored copy of the advertisement activation data of FIG. 1 and an addition of the advertisement activation data to the advertisement activation database if the stored copy of the advertisement data is not found, according to one embodiment.

FIG. 4 is a flow chart demonstrating the processes and conditions to be met to generate a customized advertisement, according to one embodiment.

FIG. 5 is a schematic diagram of capturing an image of a product to generate a customized advertisement to a user of a mobile device based on an extraction of a temporal data and a geographical data of an advertisement activation data and a calculation of an optimal price of a virtual advertisement product based on the customized advertisement, according to one embodiment.

FIGS. 6A-B are user interface views of a third party application on a mobile device, depicting a presentation of a customized advertisement based on capturing an image of a landmark, according to one embodiment.

FIG. 7 is a user interface view depicting a user login screen, according to one embodiment.

FIG. 8 is a user interface view depicting a user menu, according to one embodiment.

FIG. 9 is a user interface view providing a capability to a user to add a listing to a database, according to one embodiment.

FIG. 10 is a user interface view providing a capability to a user to choose a date corresponding to the listing added in FIG. 9, according to one embodiment.

FIG. 11 is a user interface view illustrating location-based leasing and pricing information, according to one embodiment.

FIG. 12 is a user interface view providing a capability to a user to provide a description corresponding to the listing added in FIG. 9, according to one embodiment.

FIG. 13 is a user interface view providing a detailed view of the listing added in FIG. 9, according to one embodiment.

FIG. 14 is a user interface view showing an advertisement associated with the listing added in FIG. 9, according to one embodiment.

Other features of the present embodiments will be apparent from the accompanying drawings and from the detailed description that follows.

### DETAILED DESCRIPTION

Disclosed are a method, system, and/or apparatus to lease a virtual advertisement product to an advertiser based on temporal and geographical data related to an image captured by a user of a mobile device.

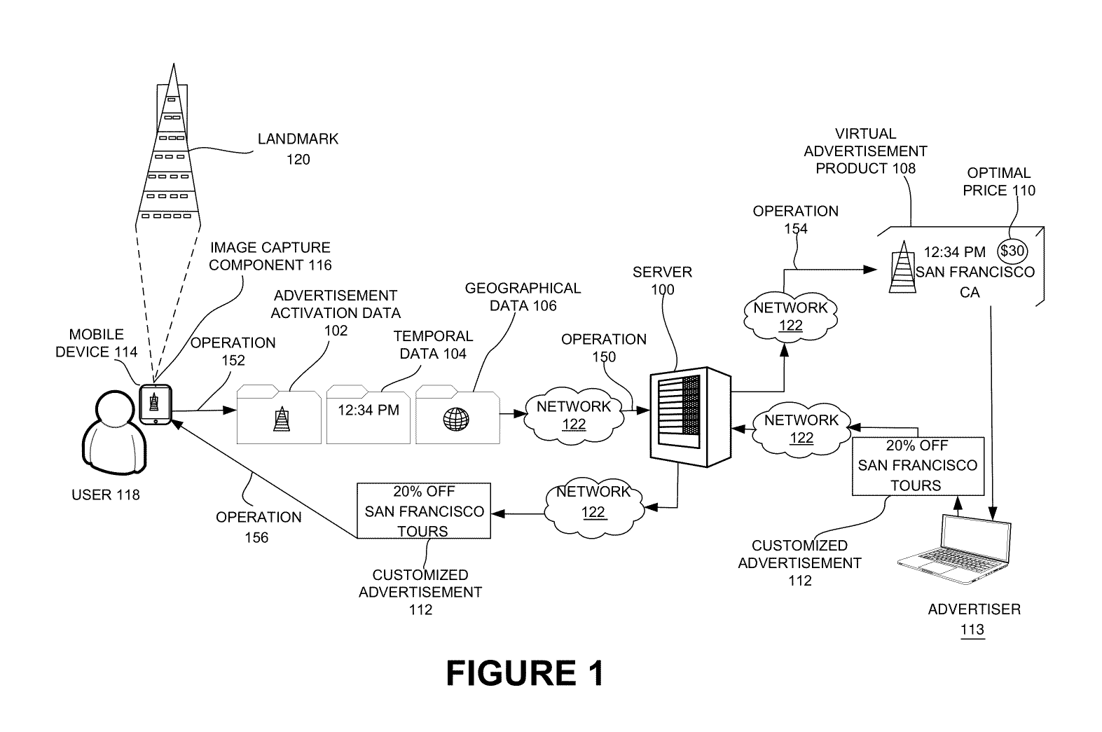

FIG. 1 is a schematic diagram of capturing an image of a landmark 120 to generate a customized advertisement 112 to a user 118 of a mobile device 114 based on an extraction of a temporal data 104 and a geographical data 106 of an advertisement activation data 102 and a calculation of an optimal price 110 of a virtual advertisement product 108 based on the customized advertisement 112, according to one embodiment.

Specifically, the advertisement activation data 102 may be captured through a third-party photography sharing application implemented on the mobile device 114. The customized advertisement 112 may be presented through the third-party photography sharing application implemented on the mobile device 114. The customized advertisement 112 may comprise a text advertisement, an advertisement image, and/or a multimedia advertisement. A customized advertisement 112 may be generated to a user 118 of the mobile device 114 based on an analysis of the temporal data 104, the geographical data 106, the optimal price 110, and/or a content of the advertisement activation data 102.

When the advertisement activation data 102 is a coded data comprising a quick response (QR) code, a scan code, a bar code, a matrix code, and/or a graphic code, the advertisement activation data 102 may be decoded. In addition, a set of user data may be extracted from the user 118 of the mobile device 114, and the set of user data may be taken into account when calculating the optimal price 110 for the virtual advertisement product 108. The set of user data may comprise a gender data of the user 118, an age data of the user 118, and/or a contact information data of the user 118. The optimal price 110 for the virtual advertisement product 108 may be continuously configured based on an analysis of the set of user data and/or a popularity metric of the virtual advertisement product 108.

In one embodiment, the leasing of a virtual advertisement product 108 performed by a server 100 comprising a processor 202 coupled to a memory 200, the memory 200 having instructions stored thereon which, when executed by the processor 202, cause the server 100 to perform the method, includes receiving an advertisement activation data 102 from a mobile device 114 comprising an image capture component 116. The advertisement activation data 102 comprises an image data, a coded data, a text data, and/or a multimedia data captured by the mobile device 114. In addition, a temporal data 104 and a geographical data 106 concerning the advertisement activation data 102 from the mobile device 114 are extracted.

FIG. 1 additionally depicts the construction of a virtual advertisement product 108 based on the advertisement activation data 102. An optimal price 110 for the virtual advertisement product 108 is calculated by analyzing the temporal data 104 and the geographical data 106 of the advertisement activation data 102. The virtual advertisement product 108 is then leased to an advertiser 113 based on the optimal price 110 calculated.

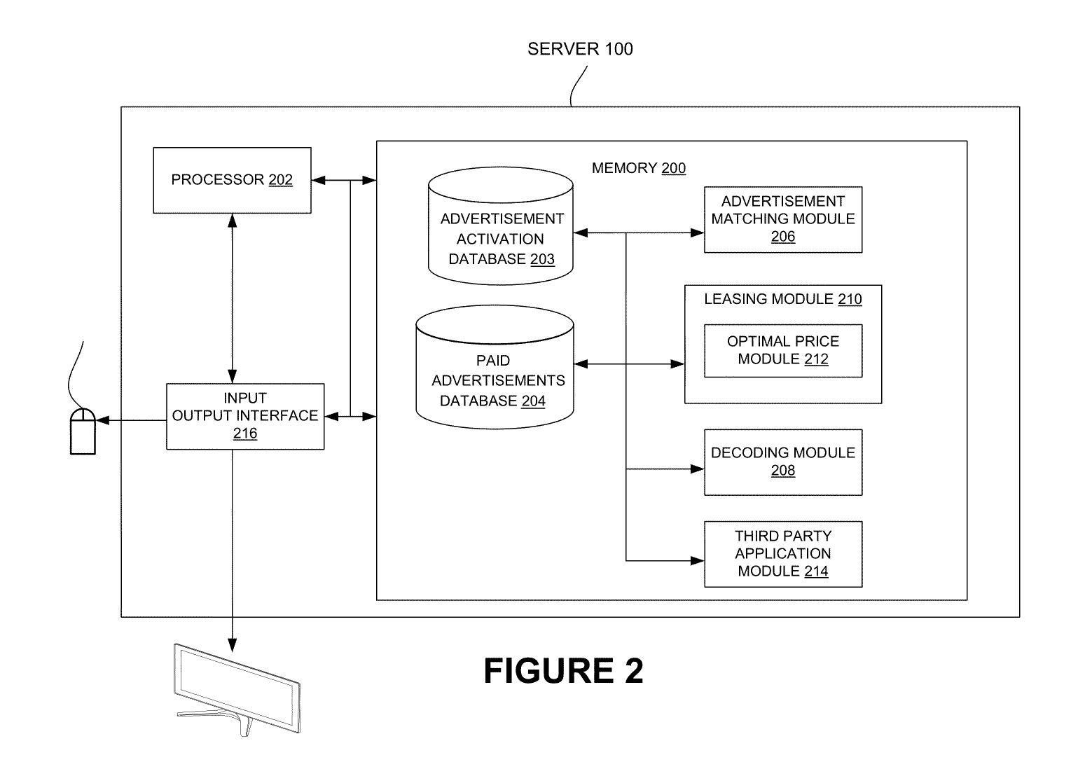

FIG. 2 is a functional block diagram depicting components of the server 100 having a processor 202 communicatively coupled to an input/output interface 216 and a memory 200, the memory 200 comprising an advertisement activation database 203, a paid advertisements database 204, an advertising matching module 206, a leasing module 210, a decoding module 208, and a third party application module 214, according to one embodiment.

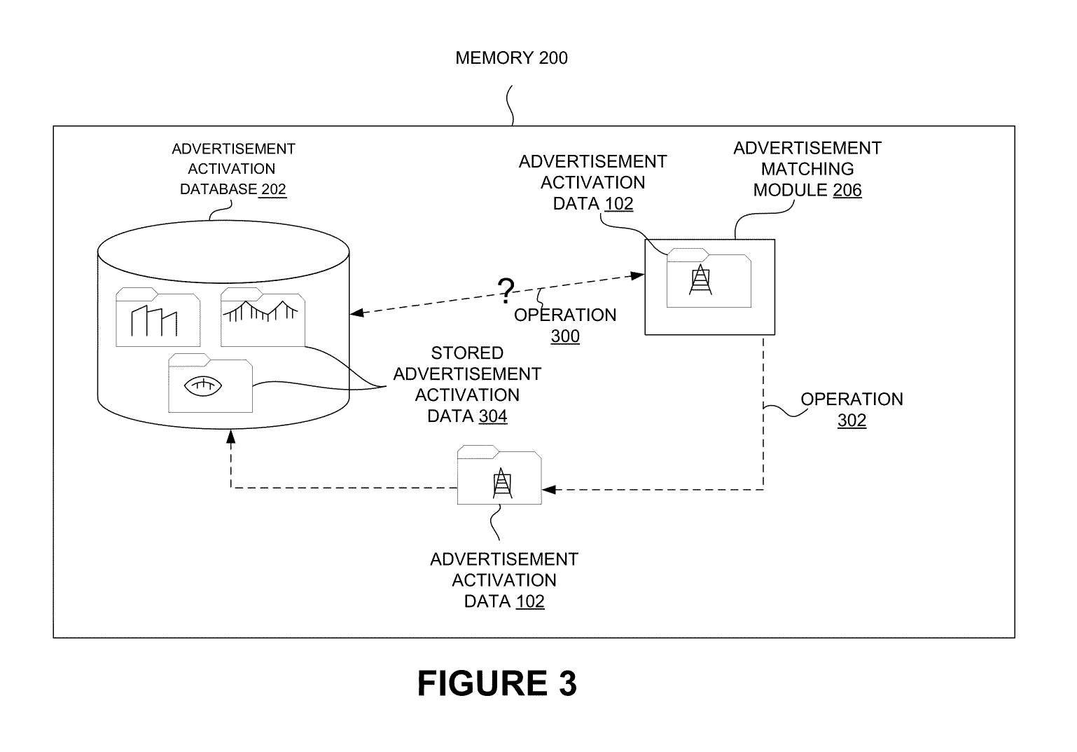

FIG. 3 is a schematic diagram of the memory 200 of FIG. 2, demonstrating a query of an advertisement activation database 203 for a stored copy of the advertisement activation data 102 of FIG. 1 and an addition of the advertisement activation data 102 to the advertisement activation database 203 if the stored copy of the advertisement activation data 102 is not found, according to one embodiment. In one embodiment, a method includes querying an advertisement activation database 203 for a stored copy of the advertisement activation data 102. The method also involves adding the advertisement activation data 102 to the advertisement activation database 203 if the stored copy of the advertisement data 304 is not found. In another embodiment, a server 100 comprises instructions to query the advertisement activation database 203 for a stored copy of the advertisement activation data 304, and add the advertisement activation data 102 to the advertisement activation database 203 if the stored copy of the advertisement data 304 is not found.

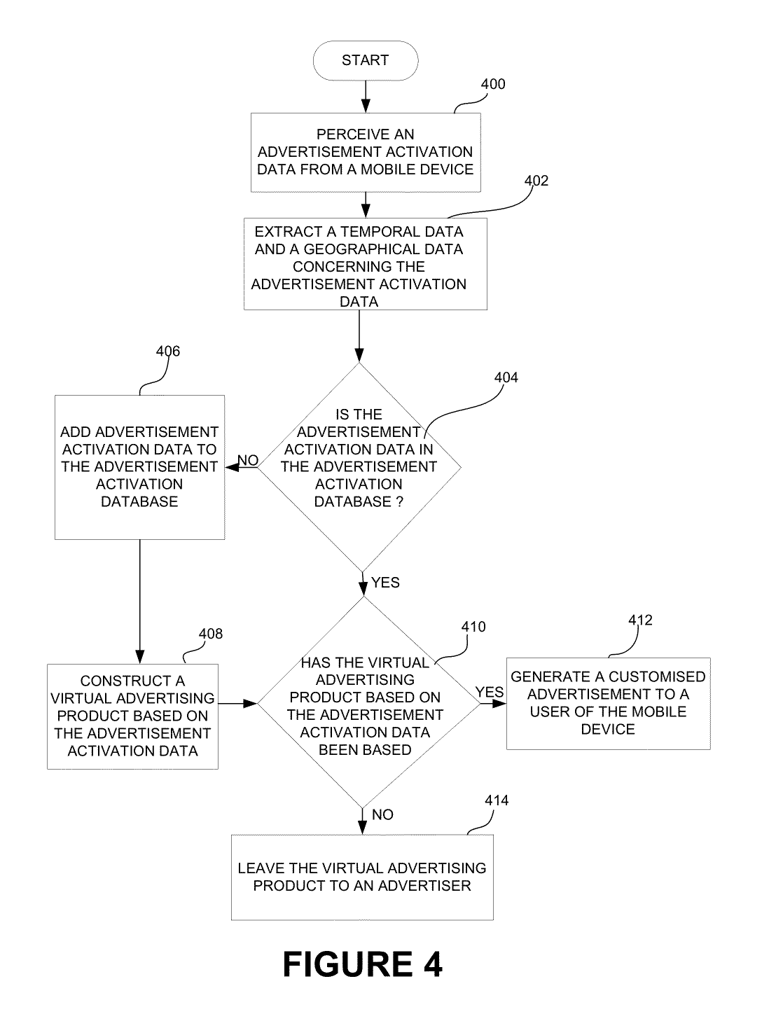

FIG. 4 is a flow chart demonstrating the processes and conditions to be met to generate a customized advertisement 112, according to one embodiment. Operation 400 involves receiving an advertisement activation data 102 from a mobile device 114. Operation 402 involves extracting a temporal data 104 and a geographical data 106 concerning the advertisement activation data 102. Condition 404 is a checkpoint determining whether the advertisement activation data 102 is stored in the advertisement activation database 203. If not, operation 406 adds the advertisement activation data 102 to the advertisement activation database 203, followed by operation 408, in which a virtual advertisement (advertising in figures) product 108 is constructed based on the advertisement activation data 102. If the advertisement activation data 102 is found in the advertisement activation database 203, condition 410 determines whether the virtual advertisement product 108 based on the advertisement activation data 102 has been constructed. If not, operation 412 leases the virtual advertisement product 108 to an advertiser. If the virtual advertisement product 108 based on the advertisement activation data 102 has been constructed, then operation 414 generates a customized advertisement 112 to a user 118 of the mobile device 114.

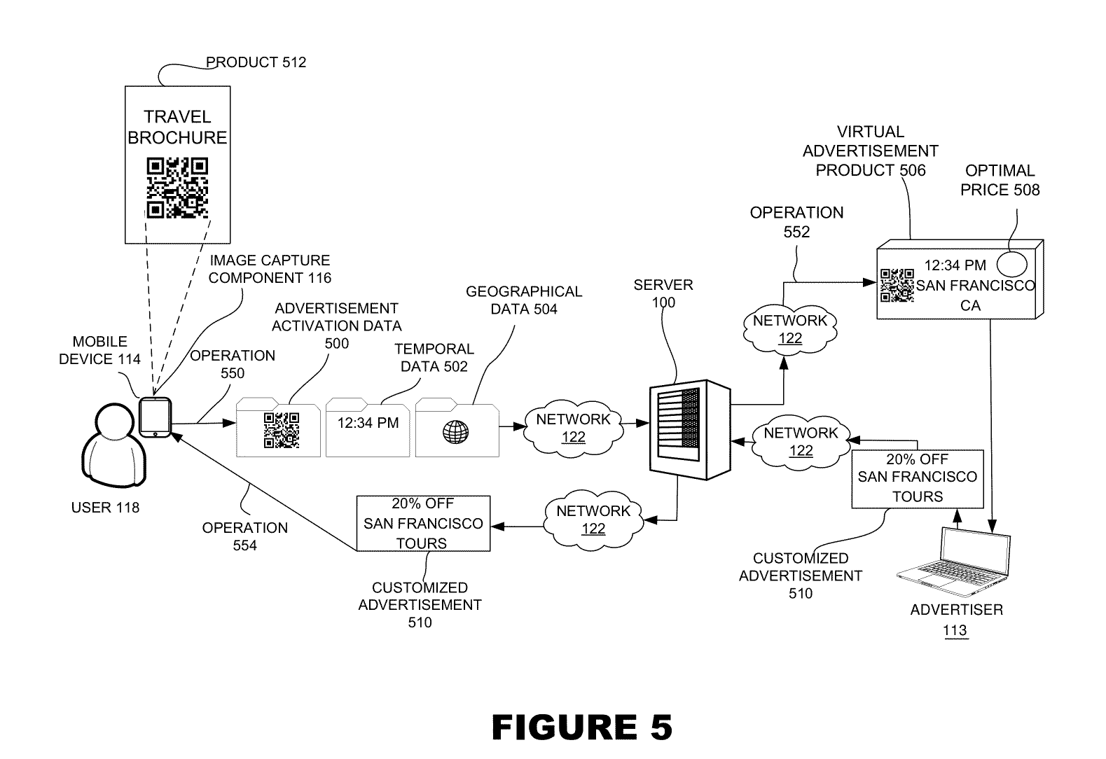

As another embodiment of FIG. 1, FIG. 5 is a schematic diagram of capturing an image of a product 512 to generate a customized advertisement 510 to a user of a mobile device based on an extraction of a temporal data 502 and a geographical data 504 of an advertisement activation data 500 and a calculation of an optimal price 508 of a virtual advertisement product 506 based on the customized advertisement 510, according to one embodiment.

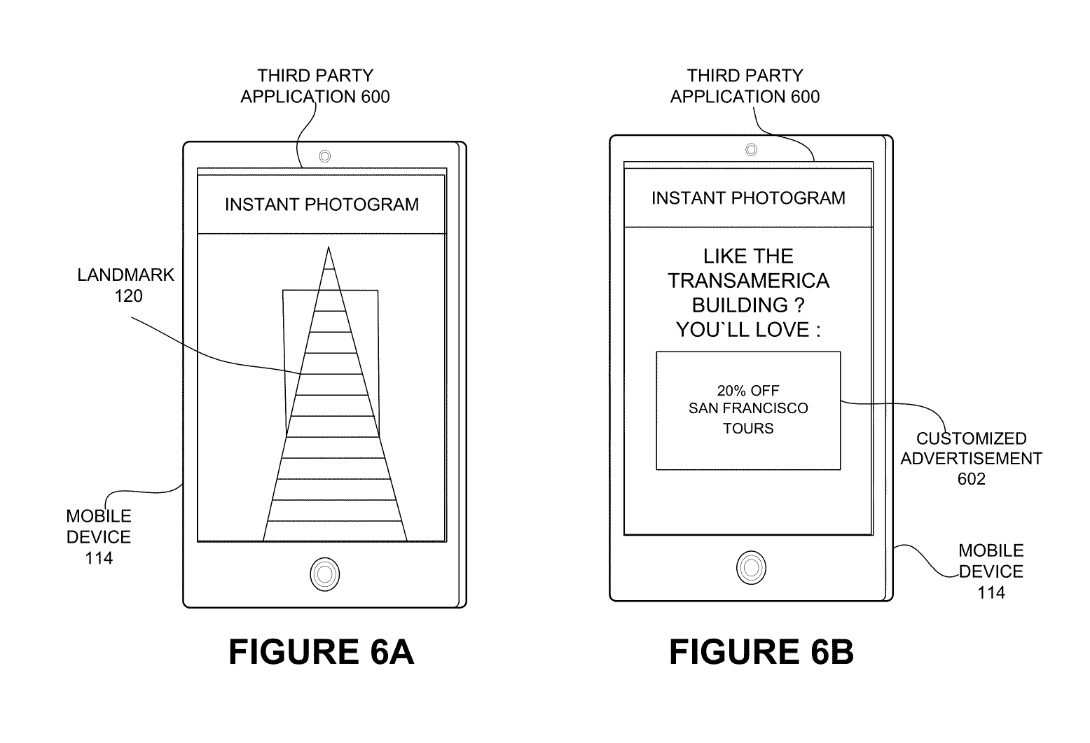

FIGS. 6A and 6B are user interface views of a third party application 600 on a mobile device 114, depicting a presentation of a customized advertisement 602 based on capturing an image of a landmark 120, according to one embodiment. The customized advertisement 602 may be associated with the landmark 120 and may be displayed on the mobile device 114.

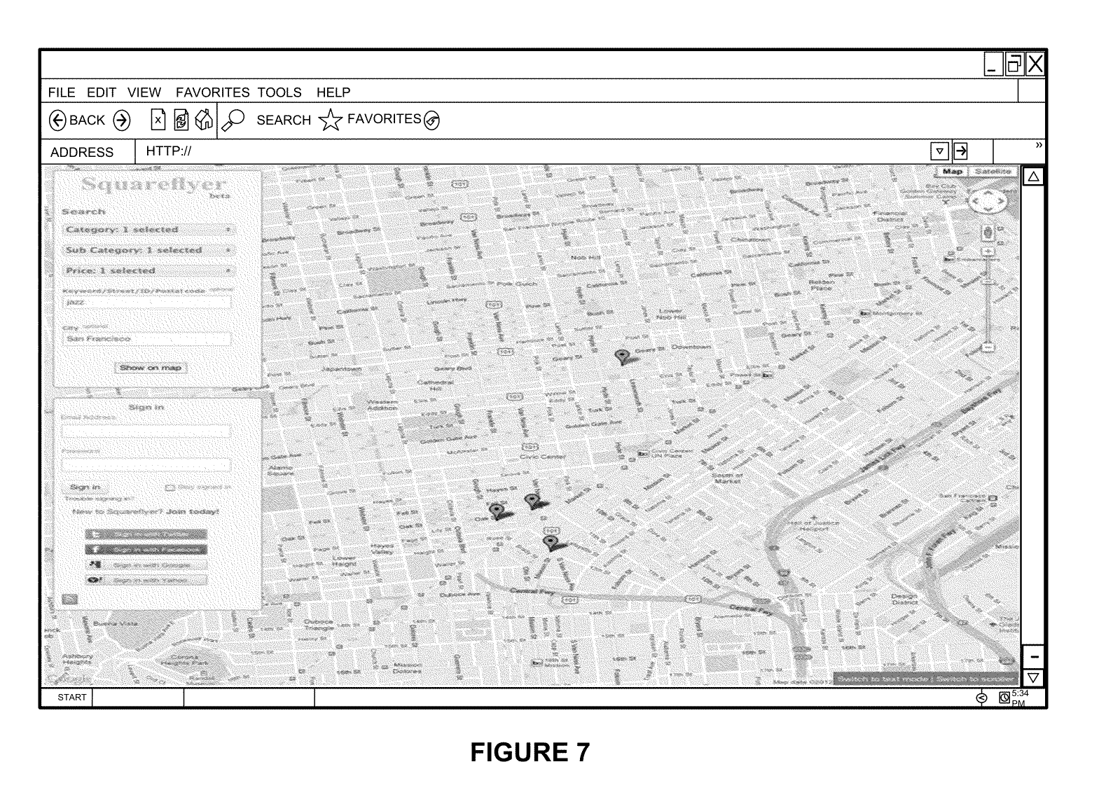

FIG. 7 is a user interface view depicting a user login screen, according to one embodiment.

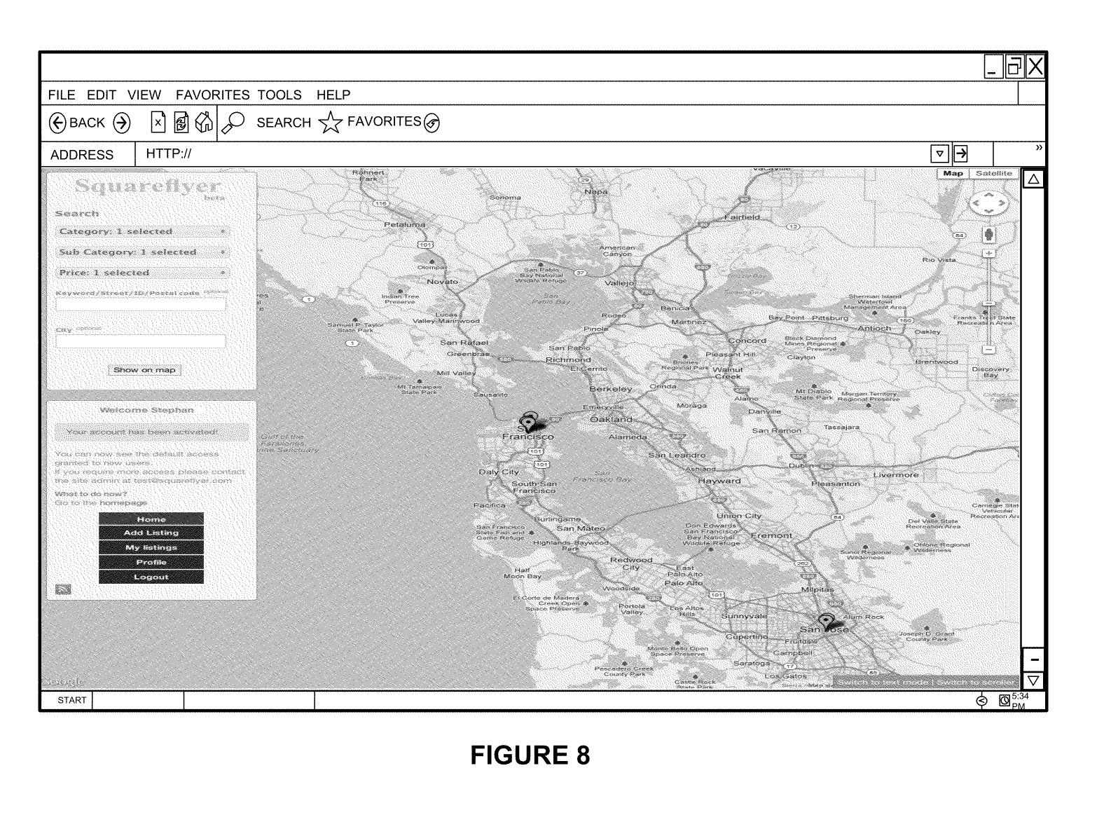

FIG. 8 is a user interface view depicting a user menu, according to one embodiment.

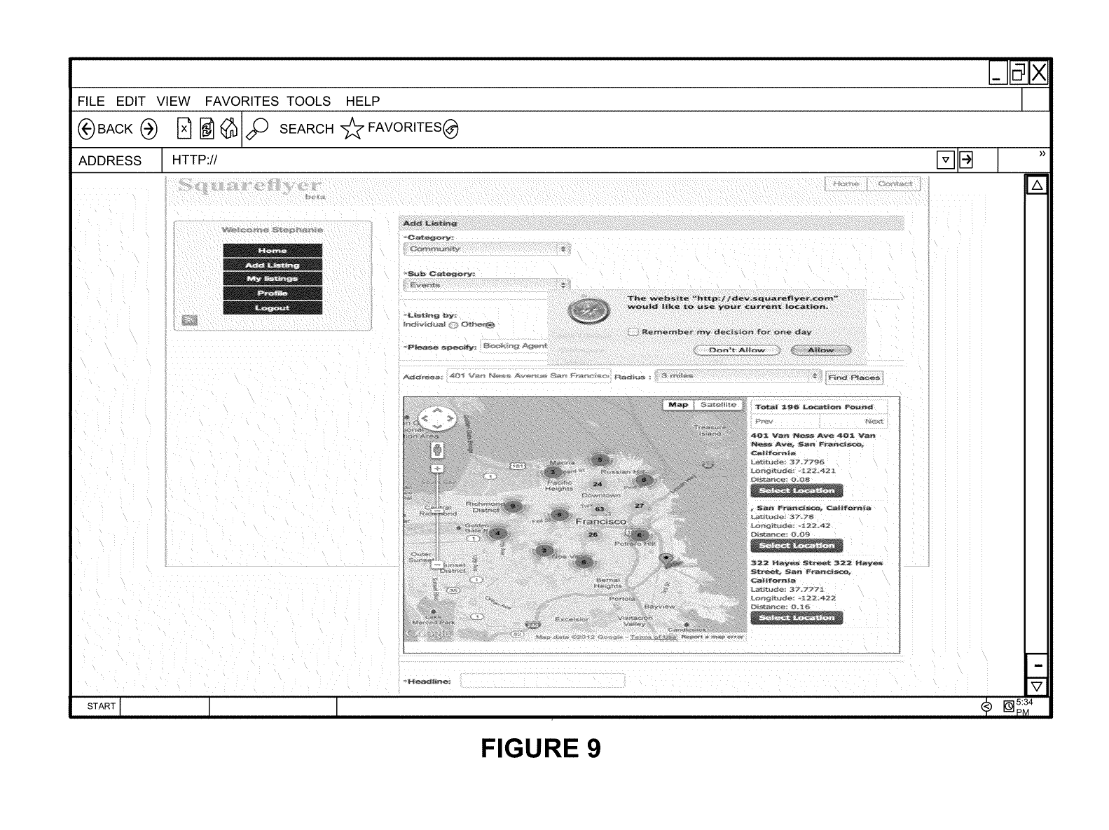

FIG. 9 is a user interface view providing a capability to a user to add a listing to a database, according to one embodiment.

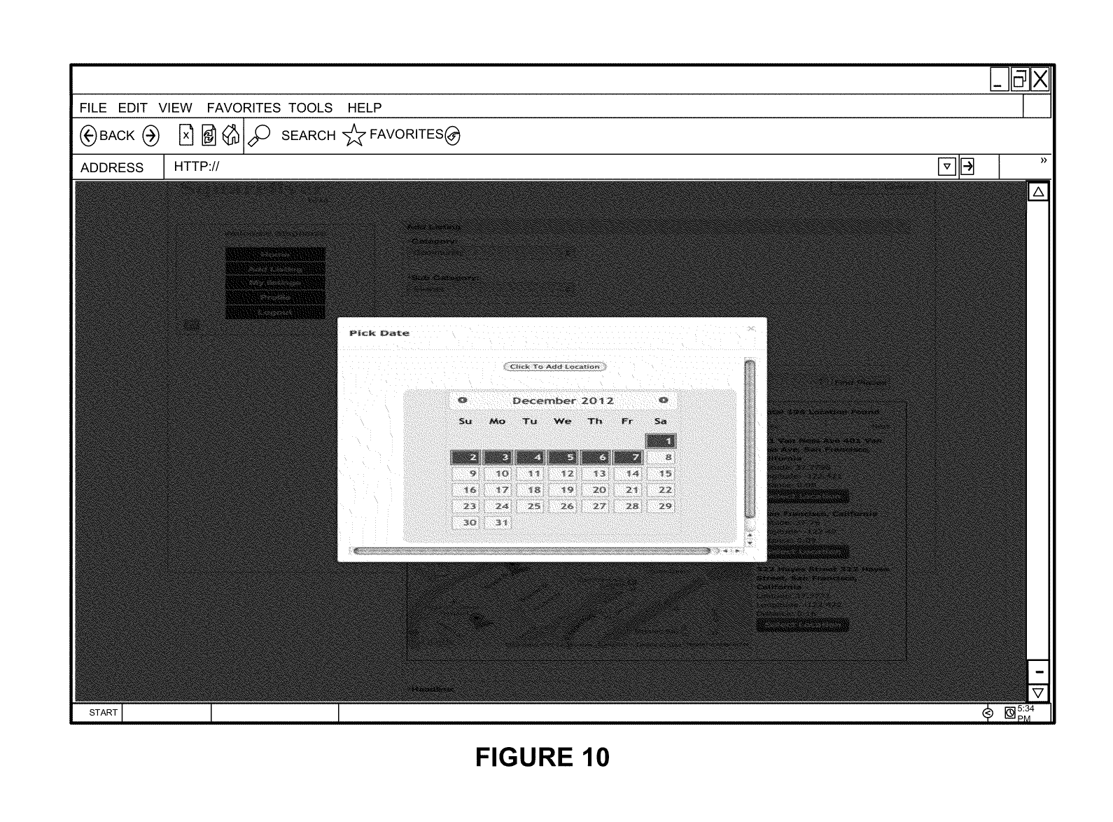

FIG. 10 is a user interface view providing a capability to a user to choose a date corresponding to the listing added in FIG. 9, according to one embodiment.

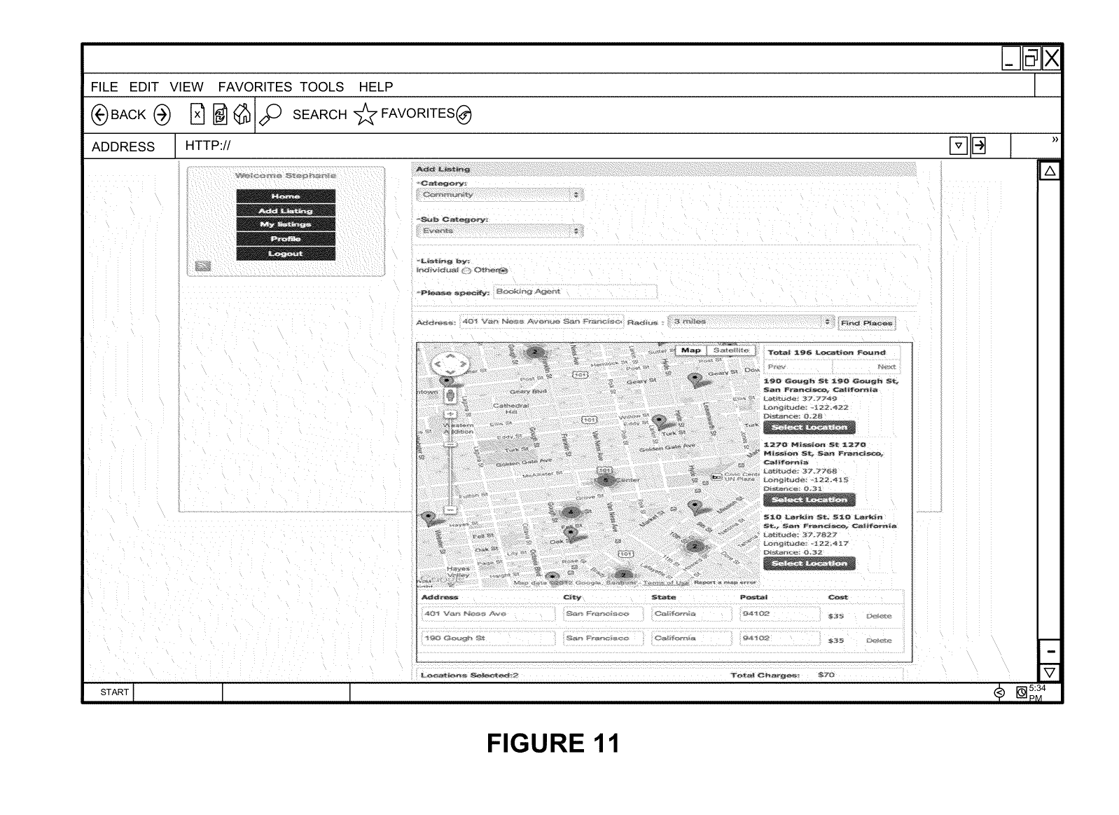

FIG. 11 is a user interface view illustrating location-based leasing and pricing information, according to one embodiment.

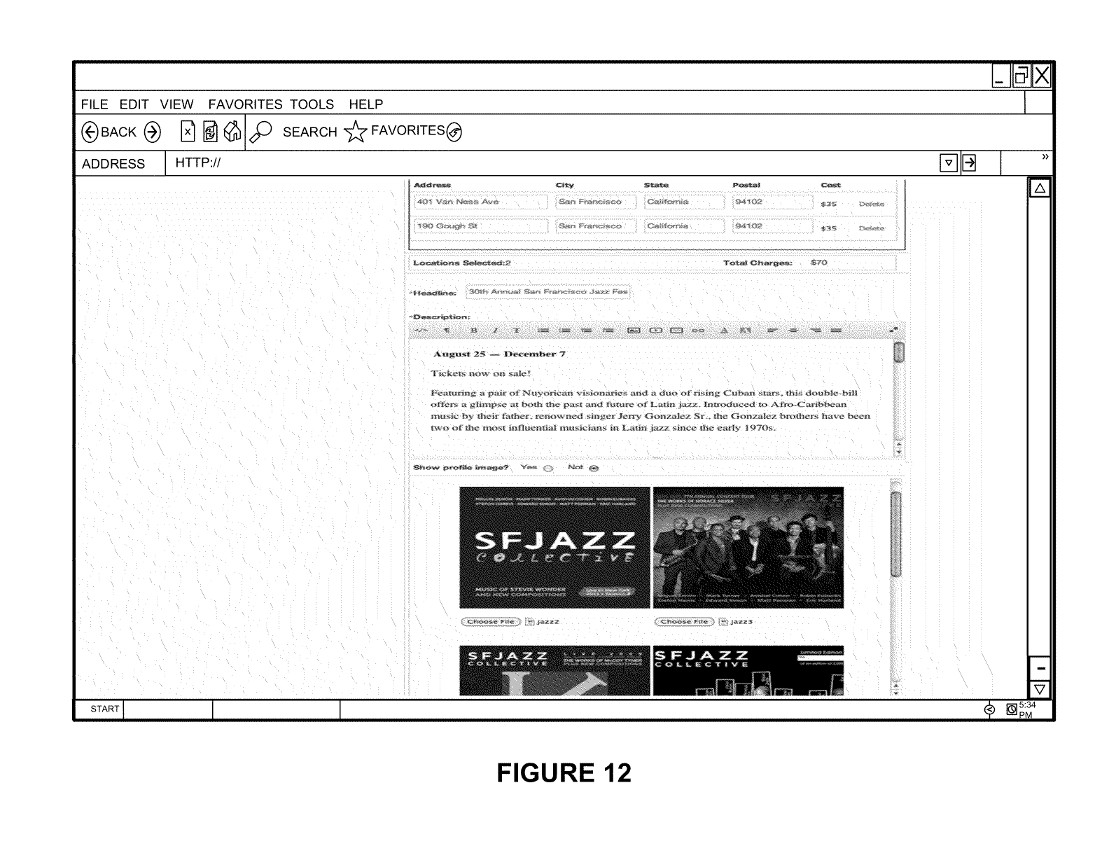

FIG. 12 is a user interface view providing a capability to a user to provide a description corresponding to the listing added in FIG. 9, according to one embodiment.

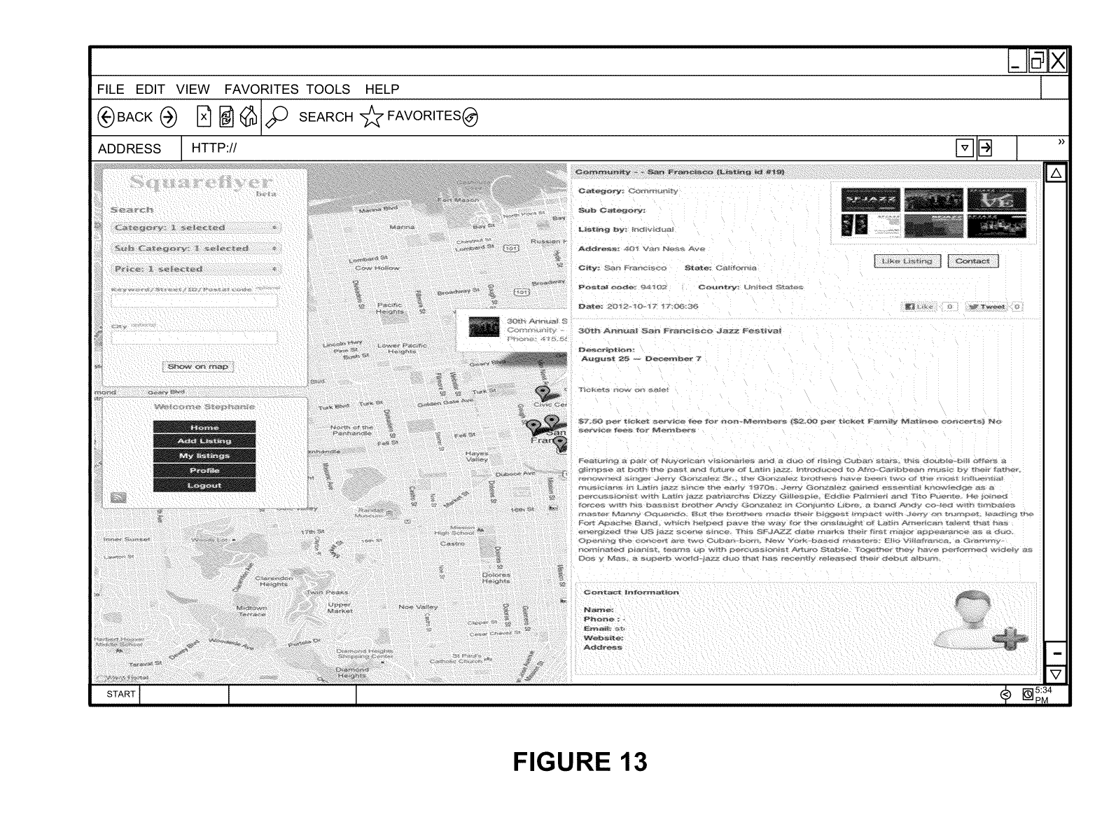

FIG. 13 is a user interface view providing a detailed view of the listing added in FIG. 9, according to one embodiment.

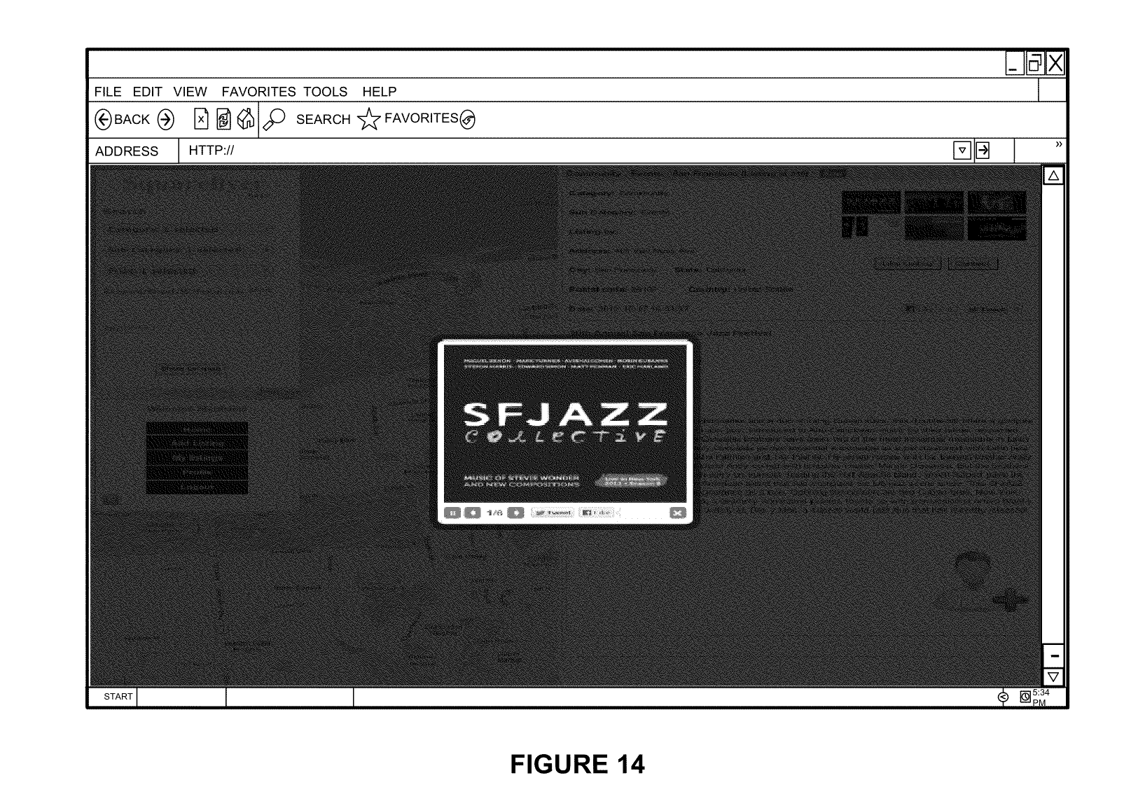

FIG. 14 is a user interface view showing a customized advertisement 112 associated with the listing added in FIG. 9, according to one embodiment.

An example will now be described in which the various embodiments will be explained in a hypothetical scenario. A mobile device user, ‘John’, who lives in ‘Anytown’, may use an application ‘XYZ’ on his mobile device to capture, send, receive, and/or share media with his friends, including ‘Alex’. Alex, a citizen of ‘Anothertown’ is also a mobile device user and may also use XYZ application to capture and capture, send, receive, and/or share media with his friends. The XYZ application may utilize a plug-in or application programming interface (API) provided by an advertisement platform company ‘ABC Inc.’ to analyze images captured by a mobile device.

In one example, an advertisement may be placed in a newspaper, magazine, website, or any printed or digital media that features advertisements. XYZ application may be used to capture an image of said advertisement. The application may analyze the image and cross-reference the image with image advertisement data saved in a database associated with a server of ABC Inc. If the image match is found, the server may return more details associated with the advertisement. For example, if the advertisement is for a local concert in Anytown, XYZ application may return information related to ticket purchasing, location of the concert, description of the locale, past/future events at the locale, places to visit around the locale, etc. In another example, if the advertisement is related to a local eatery, the returned information may consist of reviews of the eatery by other users of XYZ application, a menu of the eatery, present/future lunch/dinner specials at the eatery, description of the cuisine, etc.

Although the present embodiments have been described with reference to specific example embodiments, it will be evident that various modifications and changes may be made to these embodiments without departing from the broader spirit and scope of the various embodiments.

What is claimed is:

1. A method of leasing a virtual advertisement product performed by a server comprising a processor coupled to a memory, the memory having instructions stored thereon which, when executed by the processor, cause the server to perform a method comprising:
receiving an advertisement activation data from a mobile device comprising an image capture component,
wherein the advertisement activation data comprises at least one of an image data, a coded data, a text data, and a multimedia data captured by the mobile device;
extracting at least one of a temporal data and a geographical data concerning the advertisement activation data from the mobile device;
querying a repository database for a stored copy of the advertisement activation data;
adding the advertisement activation data to the repository database if the stored copy of the advertisement data is not found;
constructing a virtual advertising product based on the advertisement activation data;
calculating an optimal price for the virtual advertising product by analyzing at least one of the temporal data and the geographical data of the advertisement activation data; and
leasing the virtual advertising product to an advertiser based on the optimal price calculated.

2. The method of claim 1, further comprising:
generating a customized advertisement to a user of the mobile device based on an analysis of at least one of the temporal data, the geographical data, the optimal price, and a content of the advertisement activation data.

3. The method of claim 1, further comprising:
decoding the advertisement activation data when the advertisement activation data is the coded data comprising at least one of a quick response (QR) code, a scan code, a bar code, a matrix code, and a graphic code.

4. The method of claim 1, further comprising:
extracting a set of user data from the user of the mobile device; and
taking into account the set of user data when calculating the optimal price for the virtual advertising product.

5. The method of claim 4, wherein:
the set of user data comprises at least one of a gender data of the user, an age data of the user, and a contact information data of the user.

6. The method of claim 1, further comprising:
continuously configuring the optimal price for the virtual advertising product based on an analysis of at least one of the set of user data and a popularity metric of the virtual advertising product.

7. The method of claim 1, wherein:
the customized advertisement comprises at least one of a text advertisement, an advertisement image, and a multimedia advertisement.

8. The method of claim 1, wherein:
the advertisement activation data is captured through a third-party photography sharing application implemented on the mobile device and the customized advertisement is presented through the third-party photography sharing application implemented on the mobile device.

9. A server to lease a virtual advertisement product performed comprising a processor coupled to a memory, the memory having instructions stored thereon which, when executed by the processor, cause the server to:
receive an advertisement activation data from a mobile device comprising an image capture component,
wherein the advertisement activation data comprises at least one of an image data, a coded data, a text data, and a multimedia data captured by the mobile device;
extract at least one of a temporal data and a geographical data concerning the advertisement activation data from the mobile device;
query a repository database for a stored copy of the advertisement activation data;
add the advertisement activation data to the repository database if the stored copy of the advertisement data is not found;
construct a virtual advertising product based on the advertisement activation data;
calculate an optimal price for the virtual advertising product by analyzing at least one of the temporal data and the geographical data of the advertisement activation data; and
lease the virtual advertising product to an advertiser based on the optimal price calculated.

10. The server of claim 9, further comprising instructions to:
generate a customized advertisement to a user of the mobile device based on an analysis of at least one of the temporal data, the geographical data, the optimal price, and a content of the advertisement activation data.

11. The server of claim 9, further comprising instructions to:
decode the advertisement activation data when the advertisement activation data is the coded data comprising at least one of a quick response (QR) code, a scan code, a bar code, a matrix code, and a graphic code.

12. The server of claim 9, further comprising instructions to:
extract a set of user data from the user of the mobile device; and
take into account the set of user data when calculating the optimal price for the virtual advertising product.

13. The server of claim 12, wherein:
the set of user data comprises at least one of a gender data of the user, an age data of the user, and a contact information data of the user.

14. The server of claim 9, further comprising instructions to:
continuously configure the optimal price for the virtual advertising product based on an analysis of at least one of the set of user data and a popularity metric of the virtual advertising product.

15. The server of claim 9, wherein:
the customized advertisement comprises at least one of a text advertisement, an advertisement image, and a multimedia advertisement.

16. The server of claim 9, wherein:
the advertisement activation data is captured through a third-party photography sharing application implemented on the mobile device and the customized advertisement is presented through the third-party photography sharing application implemented on the mobile device.
